(19) United States
(12) Patent Application Publication
(10) Pub. No.: US 2011/0251362 A1
(43) Pub. Date: Oct. 13, 2011

(54) Olefin polymerization catalysts

(76) Inventors: Sandor Nagy, Naperville, IL (US); Reynald Chevalier, Frankfurt (DE)

(21) Appl. No.: 12/798,739

(22) Filed: Apr. 9, 2010

(51) Int. Cl. C08F 4/58; C08F 4/72; B01J 31/14; B01J 31/12

(52) U.S. Cl. 526/126; 502/155; 526/170; 502/154

(57) ABSTRACT

Catalysts useful for polymerizing olefins are disclosed. The catalysts comprise an activator and a Group 4 transition metal complex which comprises at least one monoanionic R¹N—XR² ligand, where X is O or S, and each of R¹ and R² is independently alkyl, aryl, arylalkyl, alkylaryl, or trialkylsilyl. The complexes are readily made from R¹NH—XR² precursors and are often useful as catalyst components without further purification. The catalysts have good activities, incorporate comonomers well, and provide polymers with high molecular weight.

### FIELD OF THE INVENTION

The invention relates to single-site catalysts useful for olefin polymerization. The catalysts comprise a complex that includes a monoanionic NO or NS ligand.

### BACKGROUND OF THE INVENTION

The modern era of polyolefin catalysis has been dominated by a shift toward single-site catalysts, particularly metallocenes, and their ability to make polymers with differential, tailored properties. However, metallocene-based polyolefins have not replaced earlier-generation products based on Ziegler-Natta catalysis because of tradeoffs in certain areas, such as polymer processability, polymer molecular weight, and catalyst cost. The industry is therefore evolving toward non-metallocene alternatives that can offer single-site benefits without the known drawbacks.

Single-site complexes that incorporate one or more chelating ligands are known. Usually, these complexes rely on η⁵ coordination to the metal from a cyclopentadienyl ring combined with a heteroatom-containing group that is bridged to the Cp ring (see, e.g., U.S. Pat. No. 5,064,802). Sometimes, the chelating group features two heteroatoms separated by two or more carbons. Less frequently, the two heteroatoms are bonded to each other and bond to the metal using one or both heteroatoms.

Waymouth et al. recently showed that pentamethylcyclopentadienyl (Cp*) titanium complexes that incorporate an η²-coordinated NO fragment derived from a hydroxylamine can be activated by MAO or ionic borates for making polypropylene (Organometallics 28 (2009) 405). The authors contrasted the η¹-coordinated complex resulting from use of TEMPO, a stable nitroxy radical. Similar η¹-coordination from TEMPO was shown by Schroeder et al. (Organometallics 27 (2008) 1859) in a titanium half-sandwich complex based on a tetrabenzofluorenyl ligand.

Other Cp*Ti complexes having an η²-coordinated NN fragment have been prepared from pyrazoles (Inorg. Chem. 48 (2009) 5011) or hydrazones (J. Orqanometal. Chem. 663 (2002) 173) precursors.

Early on, we described non-metallocene single-site catalysts based on amine derivatives (U.S. Pat. No. 6,204,216). The catalysts feature an anionic oxygen, sulfur, nitrogen or phosphorus and a neutral amino group that coordinate to the metal (see structure I in the '216 patent). The complexes could be made, e.g., by reacting a monocyclopentadienyl Group 4 metal complex with a lithium alkoxide salt obtained by deprotonating N,N-diethylhydroxylamine. We found, however, that some of the half-sandwich hydroxylamine-based complexes can disproportionate to metallocenes, and this unduly limits molecular weight potential. Catalyst systems that eliminate the cyclopentadienyl ring in favor of a second η²-coordinated hydroxylamine ligand would be inexpensive to make, but their activities are usually too low. None of the complexes taught in the '216 patent coordinates through a neutral O or S moiety.

U.S. Pat. No. 7,091,291 teaches three-membered titanacycles that are useful as olefin polymerization catalysts. Complexes having a monosubstituted O or S from a R¹N—OR² or R¹N—SR² ligand coordinated via an anionic nitrogen and a neutral O or S are not described.

Despite the more recent developments, the need remains for new single-site catalysts that can be made easily from inexpensive, readily accessible starting materials. Of particular interest are catalysts that have high activity and can incorporate comonomers efficiently. Ideally, the catalysts could deliver polyolefins with high molecular weight and other differential physical properties.

### SUMMARY OF THE INVENTION

The invention relates to catalysts useful for polymerizing olefins. The catalysts comprise an activator and a Group 4 transition metal complex. The complex comprises at least one monoanionic R¹N—XR² ligand, where X is O or S, and each of R¹ and R² is independently alkyl, aryl, arylalkyl, alkylaryl, or trialkylsilyl. The complexes are readily made from R¹NH—XR² precursors and are often useful as catalyst components without further purification. The catalysts have good activities, incorporate comonomers well, and provide polymers with high molecular weight.

### DETAILED DESCRIPTION OF THE INVENTION

Catalysts of the invention comprise an activator and a Group 4 transition metal complex. Group 4 transition metals are zirconium, titanium, and hafnium. Titanium and zirconium are preferred.

The catalysts include an activator. The activator helps to ionize the Group 4 metal complex and activate the catalyst toward olefin polymerization. Suitable activators are well known in the art. Examples include alumoxanes (methyl alumoxane (MAO), modified methylalumoxane (MMAO), polymeric methylalumoxane (PMAO), ethyl alumoxane, diisobutyl alumoxane), alkylaluminum compounds (triethylaluminum, diethyl aluminum chloride, trimethylaluminum, triisobutylaluminum), and the like. Suitable activators include acid salts that contain non-nucleophilic anions. These compounds generally consist of bulky ligands attached to boron or aluminum. Examples include lithium tetrakis(pentafluorophenyl)borate, lithium tetrakis(pentafluorophenyl)-aluminate, anilinium tetrakis(pentafluorophenyl)borate, and the like. Suitable activators also include organoboranes, which include boron and one or more alkyl, aryl, or arylalkyl groups. Suitable activators include substituted and unsubstituted trialkyl and triarylboranes such as tris(pentafluorophenyl)borane, triphenylborane, tri-n-octylborane, and the like. These and other suitable boron-containing activators are described in U.S. Pat. Nos. 5,153,157, 5,198,401, and 5,241,025, the teachings of which are incorporated herein by reference. Suitable activators also include aluminoboronates—reaction products of alkyl aluminum compounds and organoboronic acids—as described in U.S. Pat. Nos. 5,414,180 and 5,648,440, the teachings of which are incorporated herein by reference.

The complexes uniquely comprise at least one monoanionic R¹N—XR² ligand where X is O or S, and each of R¹ and R² is independently alkyl, aryl, arylalkyl (i.e., aryl-substituted alkyl), alkylaryl (i.e., alkyl-substituted aryl), or trialkylsilyl. The ligand is preferably η²-coordinated to the metal. Preferably, each of R¹ and R² is independently C₁-C₈ alkyl, C₆-C₂₀ aryl, C₇-C₂₀ arylalkyl, C₇-C₂₀ alkylaryl, or trimethylsilyl.

Preferred complexes have the structure:

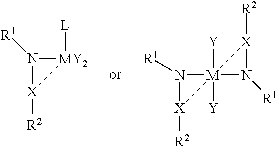

wherein M is a Group 4 transition metal, L is a substituted or unsubstituted cyclopentadienyl ligand, each Y is independently halide, alkyl, dialkylamido, aryl, alkylaryl, or arylalkyl, and X, R¹, and R² are as defined above. Substituted cyclopentadienyl ligands have a Cp moiety and include, for example, alkyl-substituted cyclopentadienyls, indenyls, fluorenyls, and the like. In particularly preferred complexes, L is cyclopentadienyl, indenyl, fluorenyl, or pentamethylcyclo-pentadienyl (Cp*). In other preferred complexes, Y is C₁-C₆ alkyl. When X is S, R¹ is preferably tert-butyl or trimethylsilyl and R² is preferably aryl. When X is O, R¹ and R² are preferably C₃-C₄ alkyl, C₆-C₂₀ aryl, or trimethylsilyl.

In certain cases, the complex may exist in bimetallic or dimerized form instead of or in addition to the monometallic structures illustrated herein, and such bimetallic or dimerized complexes are also considered suitable for use in the invention.

A few exemplary complexes:

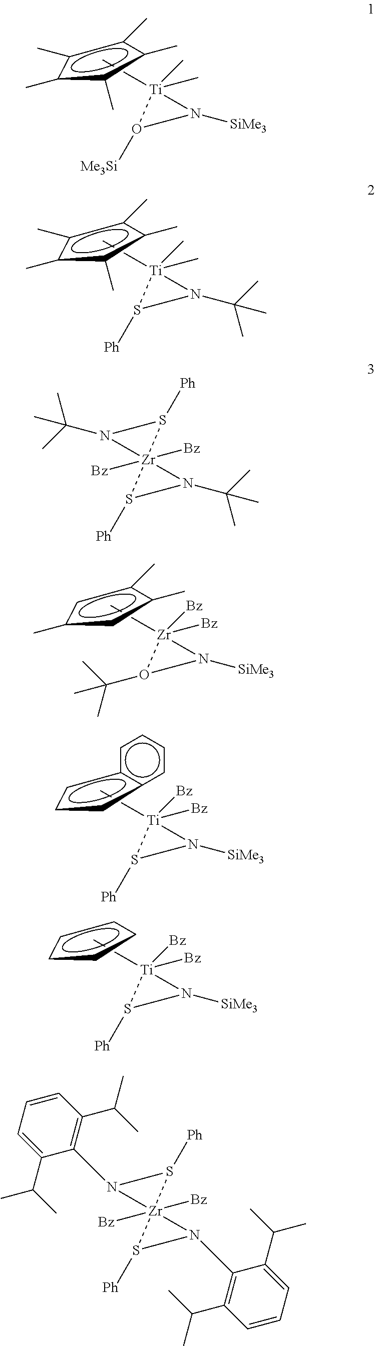

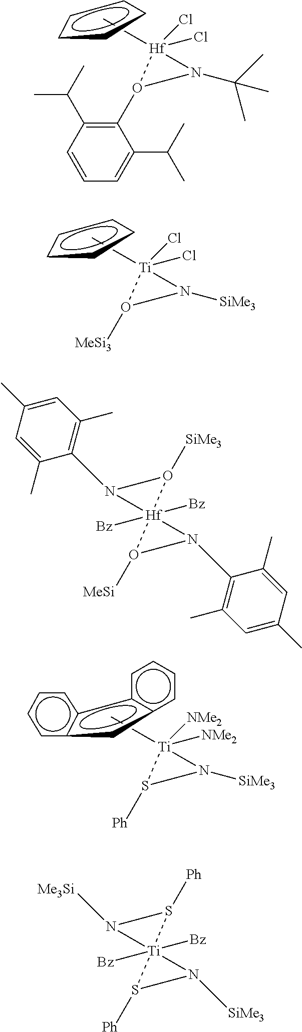

The complexes are conveniently made. Many ligand precursors having the requisite R¹N—XR² fragment are commercially available and others are easily synthesized from commercial materials. For instance, the N,O-bis(trimethylsilyl)-hydroxylamine used below to make complex 1 and the N-tert-butylbenzenesulfenamide used to make complexes 2 and 3 can be purchased from Aldrich. Often, the transition metal source need only be combined with the precursor and reacted under mild conditions to generate the complex. We found that a complex generated by combining the transition metal source and the ligand precursor can normally be used, if desired, to polymerize olefins without even isolating the complex. The ability to generate the complex “in situ” facilitates evaluation of a series of similar complexes to identify the most viable candidates for scale-up and commercialization.

In one preferred method, the complex is made by reacting a transition metal source of the formula LMY₃ or MY₄, where L, M, and Y have the meanings given above, with a ligand precursor. The ligand precursor preferably has the formula R¹—NQ-X—R² wherein Q is hydrogen or an alkali metal, and X, R¹, and R² have the meanings given above. Suitable ligand precursors in which Q is an alkali metal are easily made by reacting the corresponding protic compound with an alkali metal, metal alkyl (e.g., n-butyllithium), hydride (e.g., sodium hydride), or similar deprotonating agent.

The complexes are preferably used with an inorganic solid or organic polymer support. Suitable supports include silica, alumina, silica-aluminas, magnesia, titania, clays, zeolites, or the like. Silica is particularly preferred. The support is preferably treated thermally, chemically, or both prior to use to reduce the concentration of surface hydroxyl groups. Thermal treatment consists of heating (or “calcining”) the support in a dry atmosphere at elevated temperature, preferably greater than 100° C., and more preferably from 150 to 800° C., prior to use. A variety of different chemical treatments can be used, including reaction with organo-aluminum, -magnesium, -silicon, or -boron compounds. See, for example, the techniques described in U.S. Pat. No. 6,211,311, the teachings of which are incorporated herein by reference. Preferably, the support is calcined silica that is treated with MAO prior to combination with the complex.

The complex and activator can be deposited on the support in any desired manner. For instance, the components can be dissolved in a solvent, combined with a support, and stripped. Alternatively, an incipient-wetness technique can be used. Moreover, the support can simply be introduced into the reactor separately from the complex and activator.

In one preferred approach, the activator is MAO, the support is calcined silica, and the MAO is combined with the silica in advance. Thus, the complex sees the MAO only after the MAO has been used to treat the silica. This approach is illustrated below in Example 1.

Catalysts of the invention are useful for polymerizing olefins. Preferred olefins are ethylene and C₃-C₂₀ α-olefins such as propylene, 1-butene, 1-hexene, 1-octene, and the like. Mixtures of olefins can be used. Ethylene and mixtures of ethylene with C₃-C₁₀ α-olefins are especially preferred.

The inventive catalysts are particularly useful for making ethylene copolymers having high molecular weight and good comonomer incorporation. As shown below (see Examples 2 and 5), ethylene copolymers having weight-average molecular weights (Mw) greater than 250,000 can be made using these catalysts. Catalysts in which X═S, even without an unsubstituted or substituted cyclopentadienyl group, are particularly good for making polymers with high molecular weight. In contrast, many common metallocenes have difficulty producing ethylene copolymers having such high Mw values. The catalysts also incorporate comonomers (e.g., 1-butene, 1-hexene) well, as demonstrated by the branching results (10-36 branches per 1000 carbons, as measured by FT-IR in Examples 2, 4, 5, and 7).

Many types of olefin polymerization processes can be used, including slurry, solution, suspension, high-pressure fluid, or gas-phase processes, or a combination of these. The catalysts are particularly valuable for slurry and gas-phase processes.

The olefin polymerizations can be performed over a wide temperature range, such as −30° C. to 280° C. A more preferred range is from 30° C. to 180° C.; most preferred is the range from 60° C. to 100° C. Olefin partial pressures normally range from 15 psig to 50,000 psig. More preferred is the range from 15 psig to 1000 psig.

The following examples merely illustrate the invention. Those skilled in the art will recognize many variations that are within the spirit of the invention and scope of the claims.

### Example 1

### Preparation of Supported Complex 1=(Cp*)[O(TMS)N(TMS)]TiMe₂

Methylalumoxane (2.2 mL of 30 wt. % solution in toluene, product of Albemarle) is added at room temperature to a stirred slurry of dry silica (Davison 948 silica, product of GraceDavison, calcined 4 h at 250° C., 2.0 g) in toluene (8.0 mL). After stirring 0.5 h, the mixture is heated to 80° C. and stirred for an additional 2 h. After cooling to room temperature, the mixture is transferred into a dry-box. Separately, pentamethylcyclopentadienyltitanium trimethyl=Cp*TiMe₃ (0.092 mmol, from Strem Chemicals) is combined in toluene (2.0 mL) with N,O-bis(trimethylsilyl)hydroxylamine (0.092 mmol, Aldrich). The mixture is stirred for 0.5 h to generate complex 1 in situ. A supported catalyst is produced by adding 1 to a stirred slurry of the MAO-treated silica/toluene prepared above and stirring at room temperature for 1 h.

### Example 2

### Ethylene Polymerization

An aliquot of the catalyst slurry produced in Example 1 (corresponding to 0.012 mmol Ti) is used to copolymerize ethylene and 1-butene (110 mL) in isobutane (1 L) at 70° C. and 225 psi (15.5 bar) partial pressure of ethylene. Triisobutylaluminum (3 mL of 1 M solution in hexanes) is included in the polymerization. The polymerization is discontinued after 23 min. and the product is isolated. Yield: 2.5 g. Activity: 543 kg polymer/mol Ti/h. Polymer properties (by GPC): Mw=294,300; Mw/Mn=11; branches per 1000 carbons (by FT-IR): 36.

### Example 3

### Preparation of Complex 2=(Cp*)[S(Ph)N(t-Bu)]TiMe₂

Cp*TiMe₃ (0.0842 mmol) is combined with N-tert-butylbenzene-sulfenamide, 0.0884 mmol, from Aldrich) in toluene (0.5 mL), and the mixture is stirred at room temperature for 0.5 h to generate complex 2 in situ. Separately, trityl tetrakis(pentafluorophenyl)borate (0.10 mmol) is added to methyl-alumoxane (30 wt. % MAO in toluene, 2.0 mL). The mixture stirs for 0.5 h, and is then combined with 2 and stirred for another 0.5 h. The resulting solution is added slowly to a bed of silica (Davison 958, calcined at 600° C., 2.0 g) to give a free-flowing powder.

### Example 4

### Ethylene Polymerization

A portion of the supported catalyst produced in Example 3 (corresponding to 0.020 mmol Ti) is used to copolymerize ethylene and 1-butene using the procedure of Example 2. The polymerization is discontinued after 1 h and the product is isolated. Yield: 37 g. Activity: 1,850 kg polymer/mol Ti/h. Polymer properties: branches per 1000 carbons: 16.

### Example 5

The procedure of Example 4 is repeated except that the polymerization is performed in the presence of hydrogen (Δpsi=200 from a 7-mL vessel pressurized to 500 psi). Yield: 13.5 g. Activity: 675 kg polymer/mol Ti/h. Polymer properties: Mw=316,600; Mw/Mn=24; Ml₂=0.14, Ml₂₀/Ml₂=32.5 (by ASTM D1238, conditions E and F); branches per 1000 carbons: 29.

### Example 6

### Preparation of Complex 3=(t-BuN-SPh)₂ZrBz₂

The procedure of Example 3 is generally followed, except that tetrabenzylzirconium (0.0842 mmol) is used instead of Cp*TiMe₃, and the amount of N-tert-butylbenzenesulfenamide used is doubled (to 0.18 mmol).

### Example 7

### Ethylene Polymerization

The procedure of Example 4 is followed except that complex 3 is used instead of complex 2. Activity: 2,433 kg polymer/mole Zr/h; branches per 1000 carbons: 10.

The preceding examples are meant only as illustrations. The following claims define the invention.

We claim:

1. A catalyst comprising an activator and a Group 4 transition metal complex which comprises at least one monoanionic R¹N—XR² ligand, where X is O or S, and each of R¹ and R² is independently alkyl, aryl, arylalkyl, alkylaryl, or trialkylsilyl.

2. The catalyst of claim 1 wherein each of R¹ and R² is independently C₁-C₈ alkyl, C₆-C₂₀ aryl, C₇-C₂₀ arylalkyl, C₇-C₂₀ alkylaryl, or trimethylsilyl.

3. The catalyst of claim 1 wherein the complex has the structure: 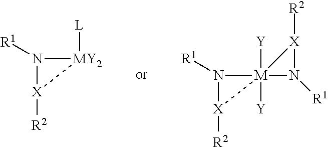
wherein M is a Group 4 metal, L is an unsubstituted or substituted cyclopentadienyl ligand, and each Y is independently halide, alkyl, dialkylamido, aryl, alkylaryl, or arylalkyl.

4. The catalyst of claim 3 wherein L is Cp*, M is Ti, and Y is C₁-C₆ alkyl.

5. The catalyst of claim 3 wherein the complex is prepared by reacting a compound of formula LMY₃ or MY₄ with a ligand precursor of formula R¹—NQ-X—R² wherein Q is hydrogen or an alkali metal.

6. The catalyst of claim 1 wherein X is S, R¹ is tert-butyl, and R² is aryl.

7. The catalyst of claim 1 wherein X is O, and R¹ and R² are trimethylsilyl.

8. The catalyst of claim 1 wherein the complex is supported on MAO-treated silica.

9. A process which comprises polymerizing one or more olefins in the presence of the catalyst of claim 1.

10. A complex comprising a Group 4 transition metal and at least one monoanionic R¹N—XR² ligand, where X is O or S, and each of R¹ and R² is independently alkyl, aryl, arylalkyl, alkylaryl, or trialkylsilyl.
